(19) United States
(12) Patent Application Publication
(10) Pub. No.: US 2005/0274107 A1
(43) Pub. Date: Dec. 15, 2005

(54) Reforming unvaporized, atomized hydrocarbon fuel

(76) Inventors: Ke Liu, Rancho Santa Margarita, CA (US); Wayne G. Wnuck, South Windsor, CT (US); Derek W. Hildreth, West Hartford, CT (US); Ronald Jan Schoonebeek, Castricum (NL)

Correspondence Address: M. P. Williams;Patent Counsel, 210 Main Street, Manchester, CT, 06040, US

(21) Appl. No.: 10/867,433

(22) Filed: Jun. 14, 2004

(51) Int. Cl. H01M 8/18; F01N 3/00; F01N 5/04

(52) U.S. Cl. 60/286; 60/280

(57) ABSTRACT

A reformer such as a CPO (18) receives a mix of fuel, moisture and oxygen from a mixing region (21) having an igniter (26, 66), which may include an inert ceramic foam (19), the fuel being provided by an atomizing nozzle (22), thereby avoiding the need for a vaporizer before use. The oxygen and moisture may comprise engine exhaust (11, 12). Fuel from a vehicle fuel tank (9), may be gasoline, diesel fuel, kerosene, jet fuel, or JP-8. The atomizing nozzle may be a gas-assist nozzle (22a), receiving the assisting gas from (a) engine exhaust (10), (b) a turbocharger (33), (c) an air pump (50) or (d) a steam generator (57). The oxygen and moisture may comprise moisturized air, which may be achieved by an ejector (41) which ingests water from a tank (43) in response to the flow of air from a pump (50) through a conduit (47). The air may be regeneratively heated (48) with the CPO exhaust. The igniter may be a glow plug (26) or a heater wire (66) coated with catalyst.

### TECHNICAL FIELD

This invention relates to reforming liquid hydrocarbon fuels without vaporizing the fuel by means of direct injection of the liquid hydrocarbon fuel through an atomizing nozzle, into either hot engine exhaust or preheated humidified air, upstream of a reformer such as a catalytic partial oxidizer (CPO) or a non-catalytic, homogenous partial oxidizer (POX), or autothermal reformer (ATR).

### BACKGROUND ART

The conventional wisdom for reforming liquid hydrocarbon fuels, such as gasoline and diesel fuel, is that the liquid fuel must be vaporized before feeding into a reformer, such as a CPO, POX, or ATR.

Referring to FIG. 1, fuel from a tank 9, which may either be diesel fuel, gasoline, kerosene, JP-8 (military fuel), or jet fuel, is provided on a line 10 to an internal combustion engine 11 which produces exhaust in a line 12. The exhaust passes through an exhaust clean-up after-treatment system 16, which may take a variety of forms to reduce particulates in the exhaust and to reduce oxides of nitrogen (NOx) in the exhaust as well.

The exhaust clean-up processing 16 receives syngas, which is a reformate including hydrogen, some CO and some CO₂, as is known, over a conduit 17 from a reformer which in this embodiment is a CPO 18. Examples of the exhaust clean-up processing may be found in U.S. patent applications having serial numbers and filed as follows: Ser. No. 10/243,105, Sep. 13, 2002; Ser. No. 10/309,712, Dec. 4, 2002; and Ser. No. 10/658,494, Sep. 8, 2003. The manner of using the syngas which is produced in accordance with the invention is not relevant to the invention; instead, the invention relates to the manner of producing the syngas for emission reduction of internal combustion engines.

In the prior art, fuel in the line 10 is vaporized in a vaporizer 65 which is raised to a sufficiently high temperature by a heater 66 which surrounds the vaporizer. The vaporized fuel in a conduit 68 has preheated air mixed with it from a conduit 69, both of which are provided to a mixer 70 at the entrance to the CPO 18 (or other reformer).

An alternative approach known to the prior art is illustrated in FIG. 2. Therein, the hot engine exhaust may be fed directly to the vaporizer 65, and the fuel injected into the vaporizer. This requires less energy from the heater 66.

Vaporizing liquid fuels, especially diesel fuel, can cause coke build-up within the vaporizer, and contributes coke particulates into the flow into the reformer, which causes deactivation of the catalyst. The vaporizer adds to the cost, weight and complexity of the system.

### DISCLOSURE OF INVENTION

Objects of the invention include: eliminating the need for a separate vaporizer for liquid hydrocarbon fuel feed stock being fed to a reformer; eliminating the problems due to coke formation in the reformation of liquid hydrocarbon fuels; eliminating catalyst deactivation due to coke; improved generation of syngas for use in regenerating NOx and particulate adsorbers in internal combustion engine systems; improved generation of hydrogen from liquid hydrocarbon fuels; and reduced cost of liquid hydrocarbon fuel reformers.

According to the present invention, liquid hydrocarbon fuel is injected directly into the hot engine exhaust of a diesel engine, or preheated humidified air, at the inlet to a hydrocarbon fuel reformer, such as a CPO, a POX or an ATR. A high degree of mixing of the liquid hydrocarbon fuel with the oxygen contained in either the engine exhaust or in the humidified air is accomplished simultaneously with the gas assisted atomization and resultant vaporization of the liquid hydrocarbon fuel.

According further to the invention, a mixer, such as inert ceramic foam, is disposed between an atomizing nozzle and the reformer. In the case of a CPO reformer, the radiation heat causes the mixer to achieve high temperature, which may be on the order of between 700° C. (1292° F.) and 1200° C. (2192° F.). The mix of heated oxygen and vaporized fuel causes an initial partial reformation of the hydrocarbon fuel into its constituents prior to reaching the CPO reformer itself. This prereformation has been referred to, and is identified herein as a “cold flame” reformation process. Use of the cold flame process not only provides a more complete reformation in the reformer, but also reduces the peak temperature of the CPO which thus reduces the long term degradation of the CPO catalyst. Use of the invention indicates that the yield of hydrogen and carbon monoxide after several hundred hours is within about one or two percent of the initial yield. This shows that deterioration of the catalyst is minimal when utilizing the present invention.

In accordance further with the invention, atomizing fuel and use of a glow plug igniter allows immediate light off of very rich air/fuel mixtures (air/fuel about 0.014), even though the lower limit of air/fuel ratios for flammability is generally considered to be 0.2, and light off of the CPO reformer at about 175° C. (350° F.), which is a much lower temperature than the 350° C. (660° F.) nominally required for light off without the invention.

In further accord with the invention, a hydrocarbon fuel igniter comprises a catalyst coated heater wire.

Other objects, features and advantages of the present invention will become more apparent in the light of the following detailed description of exemplary embodiments thereof, as illustrated in the accompanying drawing.

### BRIEF DESCRIPTION OF THE DRAWINGS

FIG. 1 is a simplified schematic diagram of an engine system of the prior art employing a fuel vaporizer to create syngas for use in cleaning the exhaust of the engine.

FIG. 2 is a simplified schematic diagram of an alternative prior art system employing a vaporizer.

FIG. 3 is a simplified schematic diagram of an engine system utilizing the present invention to create syngas for use in cleaning the exhaust of the engine.

FIG. 4 is a partial, simplified schematic diagram of the configuration of FIG. 1 but with a gas-assist nozzle using hot engine exhaust as the assisting gas.

FIG. 5 is a partial, simplified schematic diagram of the configuration of FIG. 1 but with a gas-assist nozzle using turbocharger air as the assisting gas.

FIG. 6 is a simplified schematic diagram of a system for generating syngas from unvaporized fuel and humidified air.

FIG. 7 is a partial schematic diagram of a steam-assisted nozzle.

FIG. 8 is a simplified schematic diagram of another system for generating syngas from unvaporized fuel and humidified air with an air-water bubbler.

FIG. 9 is a simplified schematic diagram of a system generating syngas from fuel and exhaust through a gas assist atomizing fuel nozzle, ignited at the inlet to the clean-up processing.

FIG. 10 is a fragmentary, simplified perspective view of an alternative igniter in accordance with the invention.

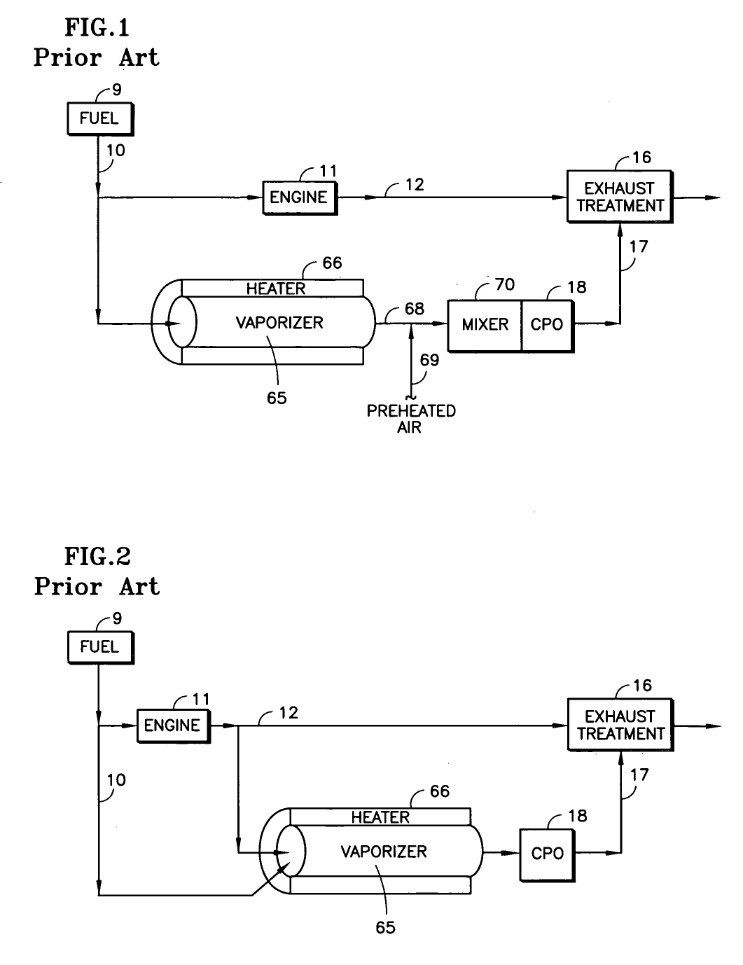

### MODE(S) FOR CARRYING OUT THE INVENTION

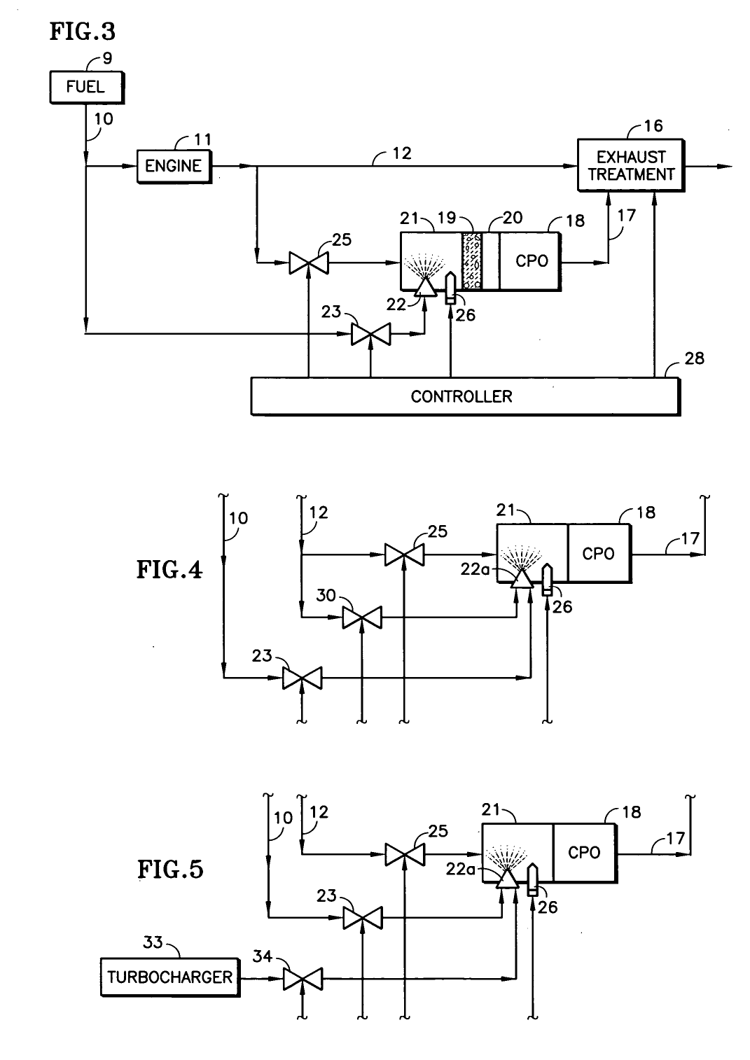

In a first embodiment of the invention illustrated in FIG. 3, the CPO 18 may have a high temperature structural support, such as an inert ceramic foam 19, separated from the CPO entrance by a gap 20, which will provide partial conversion of the hydrocarbon fuel as it reaches an elevated temperature. Within a mixing chamber 21, fuel is provided by an atomizing nozzle 22; the fuel is received through a pulse-modulated valve 23 from the fuel line 10. The mixing chamber 21 also receives engine exhaust through a valve 25 from the engine exhaust pipe 12. If desired for rapid startup, a glow plug igniter 26 is utilized to initiate ignition of a low air/fuel ratio mixture to quickly heat the CPO 18 to operating temperature. The valves 23, 25, the igniter 26, and the exhaust treatment 16 are all responsive to a controller 28.

In accordance with the invention, the fuel is at ambient temperature, and it is not vaporized prior to injection into the mixing chamber 21, but is simply atomized as it is injected through the atomizing nozzle 22 into the mix within the mixing chamber 21 where it vaporizes. The engine exhaust passing through the valve 25 supplies oxygen and moisture for the catalytic reformation process in the CPO 18.

In accordance with the invention, utilization of the inert ceramic foam 19 begins the reformation process by converting some of the fuel into some of its constituents. The fuel also consumes some oxygen which helps to reduce the peak temperature of the CPO, so that the CPO catalyst will last longer and the process will be more complete.

Referring to FIG. 4, the atomizing nozzle 22a may comprise a gas-assist atomizing nozzle, which may for instance, comprise an air-assist nozzle produced by Orbital, similar to those used for atomizing fuel oil in residential furnaces. In the embodiment of FIG. 2, the assist gas is exhaust which passes through a valve 30 under control of the controller 28.

The embodiment of FIG. 2 also illustrates that one aspect of the invention, the atomizing nozzle 22 which eliminates the need to use a vaporizer for the fuel, may be used in a CPO 18 which does not have inert ceramic foam 19 near the inlet thereof.

In the embodiment of FIG. 5, the gas for the gas assist atomizing nozzle may be provided by a vehicle's turbocharger 33, which provides a small amount of air through a valve 34 under control of the controller 28. The assist gas for a gas assist nozzle may be humidified air, engine exhaust or steam. However, other atomizing nozzles may be used, as desired, to suit any implementation of the present invention.

The invention as described, utilizing an atomizing fuel nozzle to eliminate the need for a vaporizer for the liquid hydrocarbon fuel, may thus find significant application in cleaning up internal combustion engine exhaust, such as in particulate removal devices and NOx removal devices. The invention, however, may also be used other than in vehicles with internal combustion engines.

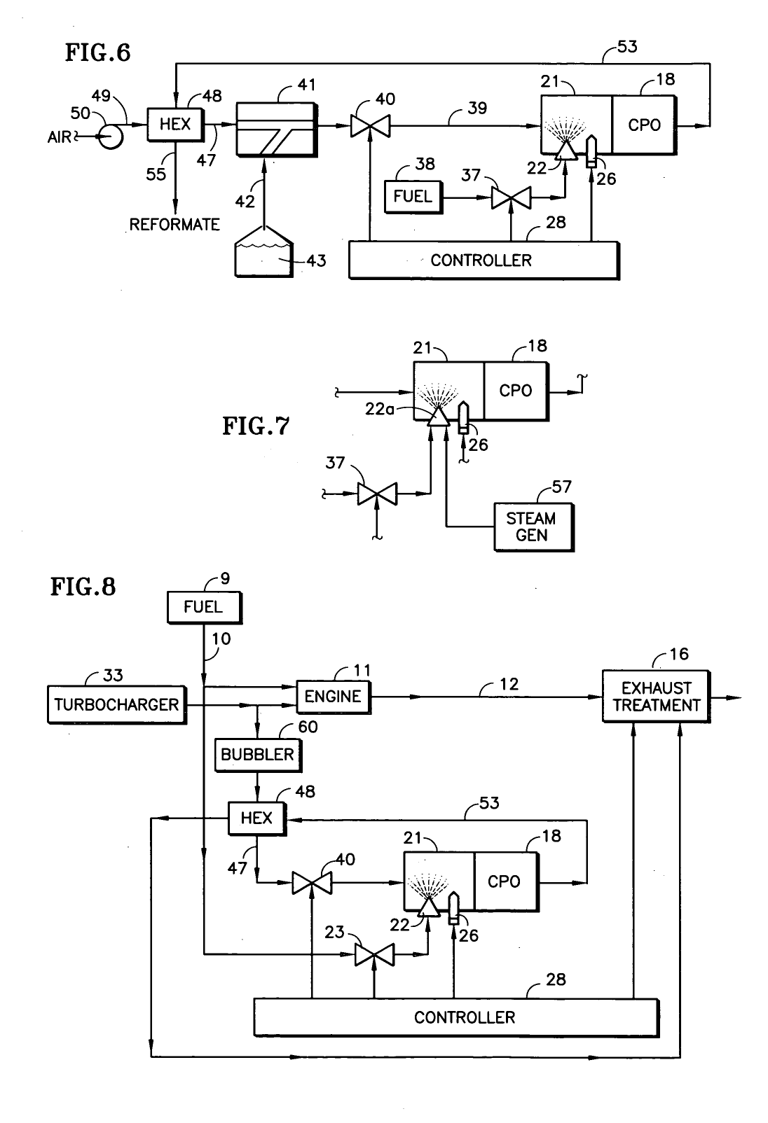

Referring to FIG. 6, the atomizing nozzle 22 receives fuel through a valve 37 from a source of fuel 38. The fuel may be gasoline, diesel fuel, or any other liquid hydrocarbon fuel, such as kerosene, JP-8 and jet fuel. Instead of engine exhaust, the mixing region 21 is provided humidified air in a conduit 39 through a valve 40 from an ejector 41 that ingests water over a line 42 from a tank of water 43. Hot air is provided on a line 47 by a heat exchanger 48 which receives air over a line 49 from an air turbocharger or an air pump 50.

The exhaust of the CPO 18, which is on the order of 700° C. to 900° C. (1292° F. to 1652° F.), is passed through a conduit 53 to the heat exchanger 48, thereby to raise the temperature of the inlet air to on the order of 300° C. to 500° C. (572° F. to 932° F.). The output in a conduit 55 is reformate, sometimes referred to as “syngas”, which includes hydrogen, CO and some CO₂, along with nitrogen, steam and unconverted hydrocarbons, all as is known to the art.

In the embodiment of FIG. 6, the igniter 26 is utilized at the start of the process to cause ignition of unpreheated air/fuel mixture, with air/fuel ratios as low as 0.014, well below the generally accepted flammability limit. Once ignited, the mixture rapidly rises to about 175° C. (350° F.) at which point the catalytic process begins, bringing the CPO to its peak temperature of on the order of between 1050° C. and 1250° C. (1922° F. and 2282° F.), after which, the igniter 26 may be disenergized and the process is self-sustaining from the heat of the CPO. In a stationary system, such as that shown in FIG. 6, steam may be used as the assist gas if a gas-assisted atomizing nozzle is used, as illustrated by the steam generator 57 in FIG. 7.

The reformate provided through the heat exchanger 48 in the conduit 55 may either be utilized as is, or it may undergo further processing, such as water/gas shift reactions, to convert CO to provide more hydrogen, and a preferential CO oxidizer, to reduce CO. The use which is made of the product of the embodiment of FIG. 6 is irrelevant to the present invention.

FIG. 8 illustrates the invention utilized with an engine wherein air from the turbocharger 33 is humidified in a bubbler/water tank combination 60, as described in the aforementioned application Ser. No. 10/243,105.

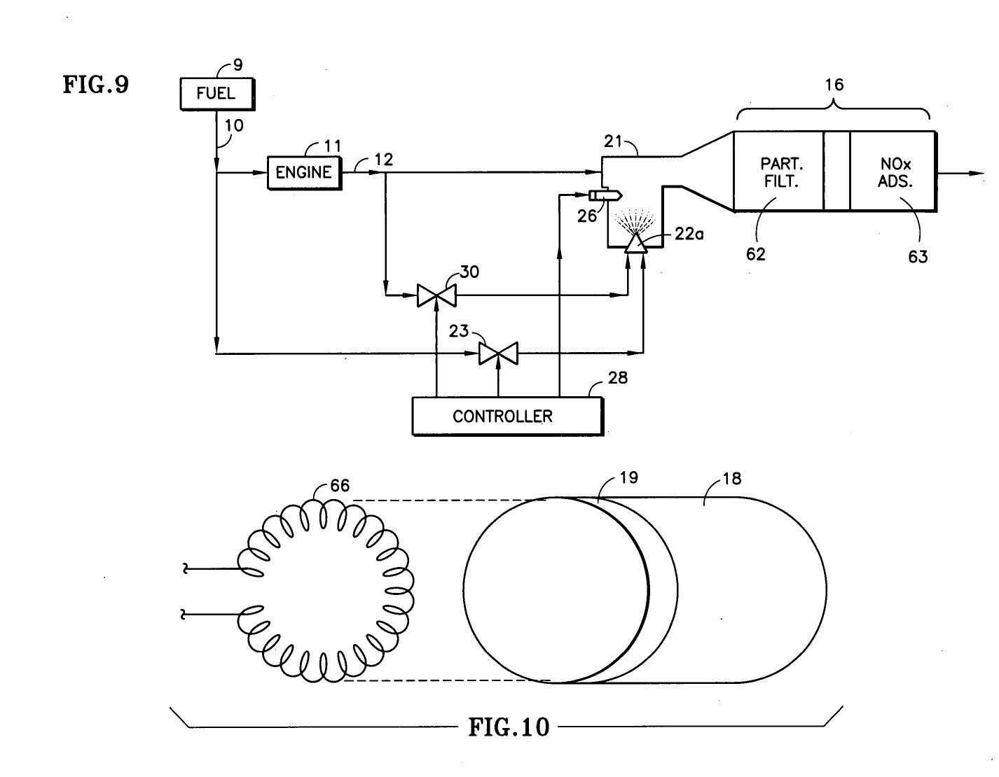

FIG. 9 illustrates that the mixing region 21 can effectively become the POX, the igniter 26 igniting the fuel and exhaust mixture passing through the gas assist atomizing nozzle, which burns additional exhaust components in the mixing chamber 21. This hot syngas mixture then flows directly into the exhaust treatment, which may comprise a catalyzed particulate filter 62 and a catalyzed NOx adsorber 63, as is known in the art. The use of the gas assist atomizing nozzle permits applying the generated syngas directly into the exhaust as shown.

The atomized liquid fuel within the mixing chamber 21, particularly if it is gasoline, is extremely explosive. Therefore, the igniter should not be a spark plug for safety reasons. Instead of using a glow plug, however, the igniter may comprise, as shown in FIG. 10, a heater wire, which may be formed in the shape of a helix 66, wash-coated with a CPO catalyst, and placed in front of the ceramic foam 19. This will cause partial oxidation of the fuel, heating the ceramic foam. This igniter may be used in a POX or to assist light-off of a CPO or an ATR.

In the invention, only sufficient oxygen should be used to reach the CPO temperature, any additional oxygen merely reducing the hydrogen yield. Without use of a catalyst, such as a homogeneous POX, the glow plug must be at a much higher temperature, and must be energized continuously.

All of the aforementioned patent applications are incorporated herein by reference.

Thus, although the invention has been shown and described with respect to exemplary embodiments thereof, it should be understood by those skilled in the art that the foregoing and various other changes, omissions and additions may be made therein and thereto, without departing from the spirit and scope of the invention.

1. A liquid hydrocarbon fuel processing system, comprising:
a reformer selected from CPO, POX and ATR, said reformer having an inlet;
exhaust treatment means disposed adjacent to said reformer and using the output of said reformer to remove contaminants from said exhaust;
a mixing chamber adjacent to and in fluid communication with the inlet of said reformer;
a source of liquid hydrocarbon fuel:
an engine burning said liquid hydrocarbon fuel and providing exhaust;
a source for providing oxygen and moisture to said mixing chamber, said source selected from a source of engine exhaust and a source of humidified air;
a liquid fuel atomizing nozzle receiving fuel from said source of fuel and providing atomized liquid hydrocarbon fuel to said mixing chamber at the inlet of said reformer;
a high temperature structural support within said mixing chamber between said atomizing nozzle and the inlet to said reformer; and
an igniter adjacent said nozzle and effective to ignite said atomized liquid hydrocarbon fuel, said igniter comprising a heater wire coated with a CPO catalyst.

2. A liquid hydrocarbon fuel processing system, comprising:
a reformer selected from CPO, POX and ATR, said reformer having an inlet;
a source of liquid hydrocarbon fuel;
a liquid fuel atomizing nozzle for providing atomized liquid hydrocarbon fuel to the inlet of said reformer; and
an igniter adjacent said nozzle and effective to ignite said atomized liquid hydrocarbon fuel.

3. A liquid hydrocarbon fuel processing system, comprising:
a mixing chamber;
a source of liquid hydrocarbon fuel;
an engine burning said liquid hydrocarbon fuel and providing exhaust to said mixing chamber;
a liquid fuel atomizing nozzle receiving fuel from said source of fuel and providing atomized liquid hydrocarbon fuel to said mixing chamber;
an igniter adjacent said nozzle and effective to ignite said atomized liquid hydrocarbon fuel thereby causing said mixing chamber to function as a POX reformer; and
exhaust treatment means disposed adjacent to said POX reformer and using the output of said reformer to remove contaminants from said exhaust.

4. A liquid hydrocarbon fuel processing system, comprising:
a reformer selected from CPO, POX and ATR, said reformer having an inlet;
a mixing chamber adjacent to and in fluid communication with the inlet of said reformer;
a source of liquid hydrocarbon fuel;
a source for providing oxygen and moisture to said mixing chamber, said source selected from a source of engine exhaust and a source of humidified air;
a liquid fuel atomizing nozzle receiving fuel from said source of fuel and providing atomized liquid hydrocarbon fuel to said mixing chamber at the inlet of said reformer;
a high temperature structural support within said mixing chamber between said atomizing nozzle and the inlet to said reformer; and
an igniter adjacent said nozzle and effective to ignite said atomized liquid hydrocarbon fuel.

5. A system according to any one of claims 1-4 wherein said liquid fuel atomizing nozzle is a gas assist nozzle receiving assist gas from either (a) engine exhaust, (b) an air blower, (c) a turbocharger or (d) a steam generator.

6. A system according to claims 1 or 4 wherein:
said high temperature structural support is an inert ceramic foam.

7. A system according to any one of claims 1-4 wherein said igniter is a glow plug.

8. A system according to any one of claims 1-4 wherein said igniter is a heater wire coated with catalyst.

9. A system according to claim 8 wherein said heater wire is in the shape of a helix.

10. A method of reforming hydrocarbon fuel comprising:
atomizing liquid hydrocarbon fuel at the inlet of a reformer selected from a CPO, a POX and an ATR;
providing oxygen at said inlet: and
igniting the air/atomized-fuel mixture at said inlet.

11. Apparatus for reforming hydrocarbon fuel comprising:
a reformer selected from a CPO, a POX and an ATR;
a fuel atomizer for atomizing liquid hydrocarbon fuel at the inlet to said reformer;
means providing oxygen at said inlet; and
an igniter for igniting the air/atomized-fuel mixture at said inlet.

12. A liquid hydrocarbon fuel processing system, comprising:
a reformer selected from CPO, POX and ATR, said reformer having an inlet;
a source providing liquid hydrocarbon fuel to the inlet of said reformer; and
an igniter adjacent said nozzle and effective to ignite said liquid hydrocarbon fuel, said igniter comprising a heater wire coated with a CPO catalyst.

13. A system according to claim 12 wherein said heater wire is in the shape of a helix.
